(19) United States
(12) Patent Application Publication
(10) Pub. No.: US 2015/0235292 A1
(43) Pub. Date: Aug. 20, 2015

(54) PRESENTING ITEMS CORRESPONDING TO A PROJECT

(71) Applicants: Venkata Yerubandi, Dublin, CA (US); Puneet Chandra, Mountain View, CA (US); Sandeep Chatra Raveesh, Sunnyvale, CA (US); Chelsey Chow, San Jose, CA (US)

(72) Inventors: Venkata Yerubandi, Dublin, CA (US); Puneet Chandra, Mountain View, CA (US); Sandeep Chatra Raveesh, Sunnyvale, CA (US); Chelsey Chow, San Jose, CA (US)

(73) Assignee: EBAY INC., SAN JOSE, CA (US)

(21) Appl. No.: 14/181,163

(22) Filed: Feb. 14, 2014

(51) Int. Cl. G06Q 30/06

(52) U.S. Cl. CPC G06Q 30/0623

(57) ABSTRACT

A request that indicates a project to be completed may be received from a device operated by a user. A plurality of items that are being used together to complete the project may be determined. The plurality of items may each be listed as being available for sale. A single display page may be generated that includes the plurality of items that are used together to complete the project. Lastly, the generated single display page may be presented to the device operated by the user.

### TECHNICAL FIELD

The subject matter disclosed herein generally relates to the processing of data. Specifically, the present disclosure addresses systems and methods to present a plurality of items corresponding to a project.

### BACKGROUND

A user may browse online to search individually for items that are used to complete a project. However, searching individually for items can be time consuming and can result in compatibility problems regarding the items.

### BRIEF DESCRIPTION OF THE DRAWINGS

Some embodiments are illustrated by way of example and not limitation in the figures of the accompanying drawings.

FIG. 1 is a network diagram illustrating a network environment suitable to present a plurality of items that correspond to a project, according to some example embodiments.

FIG. 2 is a block diagram illustrating components of a project machine, according to some example embodiments.

FIG. 3 is an example user interface depicting a set of controls operable to provide search criteria, according to some example embodiments.

FIG. 4 is an example user interface depicting a display page of a plurality of items, according to some example embodiments.

FIG. 5 is an example user interface depicting a feedback page, according to some example embodiments.

FIG. 6-7 are flowcharts illustrating operations of a method of presenting a single display page that includes a plurality of items, according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

Example methods and systems are directed to presenting a plurality of items that correspond to a project. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A user may desire to complete a project. The project may involve construction of a product or accomplishment of a task. Further, completion of the project may involve a group of items. However, the user may not be able to identify the group of items or not know which items to use in completing the project. In order to relieve the burden on behalf of the user of trying to identify the group of items, an online system may assist the user by determining the group of items. The user may indicate the project in a request and the online system may determine the group of items involved in completion of the project. The online system may further display the group of items to the user on a single page. This may relieve the burden on behalf the user of having to discover each item in the group of items individually as well as their compatibility with one another.

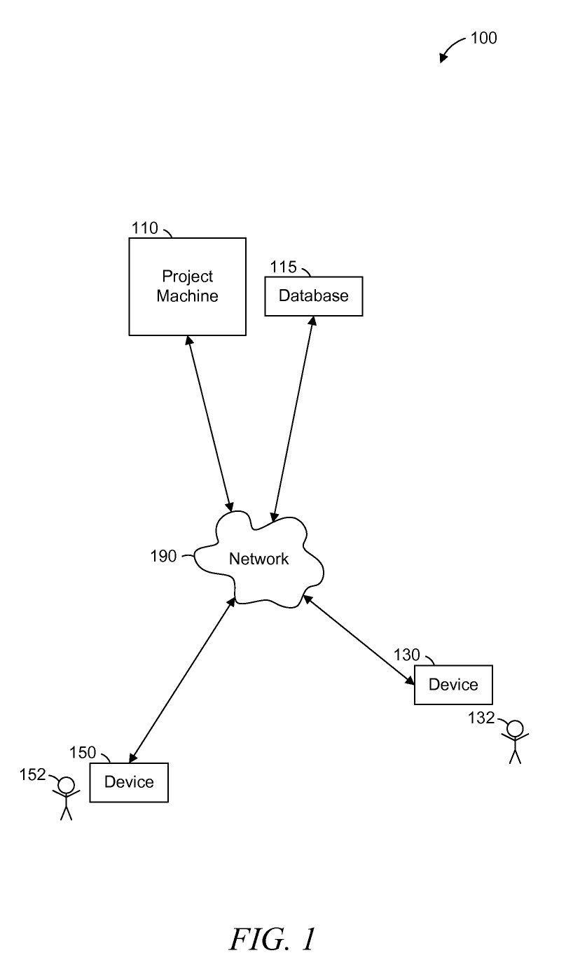

FIG. 1 is a network diagram illustrating a network environment 100 to present a plurality of items that correspond to a project, according to some example embodiments. The network environment 100 includes a project machine 110, a database 115, and devices 130 and 150, all communicatively coupled to each other via a network 190.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

A user operating a device (e.g., user 132 operating device 130) may submit a request to the project machine 110 that indicates a project. Upon receiving the request, the project machine 110 may determine a plurality of items used to complete the project. The project machine 110 may then generate a display that includes the plurality of items used to complete the project. The project machine 110 may then present the generated display to the device operated by the user.

Any of the machines, databases, or devices shown in FIG. 1 may be implemented in a general-purpose computer modified (e.g., configured or programmed) by software to be a special-purpose computer to perform one or more of the functions described herein for that machine, database, or device. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the project machine 110 and the devices 130 and 150). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

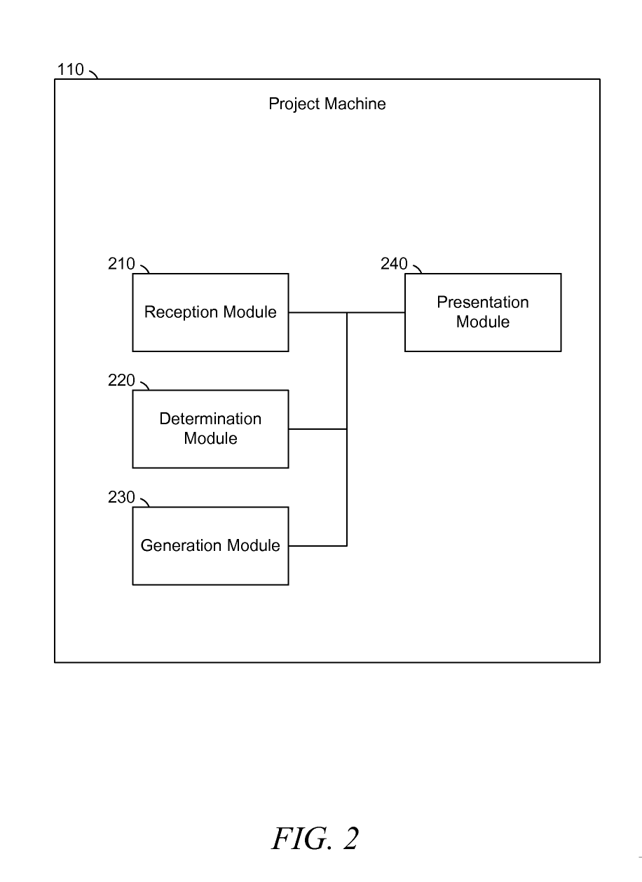

FIG. 2 is a block diagram illustrating components of the project machine 110, according to some example embodiments. The project machine 110 is shown as including a reception module 210, a determination module 220, a generation module 230, and a presentation module 240 all configured to communicate with each other (e.g., via a bus, shared memory, or a switch).

In various example embodiments, the reception module 210 is configured to receive a request that indicates a project to be completed. The request may be received from a device operated by a user (e.g., device 130 of user 132). In various example embodiments, the project to be completed may include construction of a product. The product to be constructed may be assembled together using various items, such as building a model airplane. In some situations the project to be completed may not involve construction of a product. For instance, painting a room may be a project to be completed, although painting the room does not involve constructing a product. In either case, a plurality of items may be used to complete the project, as further explained below. In various example embodiments, the reception module 210 is further configured to receive a description of a product to be constructed. In various example embodiments, the reception module 210 receives the request from the device operated by the user in response to operation of a link on a web page, as further explained below. The web page may also include a description of the project. In various example embodiments, the reception module 210 is further configured to receive search criteria from the device operated by the user. The search criteria may include the description of the project to be completed by the user. In various example embodiments, the reception module 210 is further configured to receive a previous request to purchase a plurality of items that are used to together to complete the project. The previous request may be received by the reception module 210 prior to receiving the request that indicates a project to be completed. Moreover, the previous request may be received from a previous device operated by a previous user (e.g., device 150 of user 152). For instance, a previous user may have previously requested to purchase the all of the parts needed to build a model airplane. For instance, the previous request may include the previous user browsing a listing for each of the plurality of items (e.g., items needed to build the model airplane) and adding each item to an online shopping cart. In various example embodiments, the reception module 210 is further configured to detect feedback that describes the plurality of items being used together to complete the project. The feedback may be received by the reception module 210 from the previous device operated by the previous user. For instance, the previous user may describe the experience of completing the project using the plurality of items. Further, the previous user may describe each of the plurality of items with regards to helpfulness in completing the project. For instance, each of the plurality of items may receive a positive review or a negative review. In the case of the model airplane, the previous user may have described the experience of building the model airplane and described each of the components used to build the model airplane.

In various example embodiments, the determination module 220 is configured to determine a plurality of items that are used together to complete the project indicated in the request. In various example embodiments, the plurality of items may be simultaneously used together to complete the project. In various example embodiments, the items may be physically coupled to one another in order to complete the project. Alternatively, completion of the project may comprise of various steps with a subset of the plurality of items being used at each step. Moreover, each of the plurality of items may be listed as being available for sale. For instance, the plurality of items may each have a separate item page from which the item may be purchased. In various example embodiments, the determination module 220 is further configured to determine the plurality of items based on the search criteria received from the device operated by the user (e.g., a description of the project). In various example embodiments, the determination module 220 is further configured to determine the plurality of items based on the previous request to purchase the plurality of items that are used together to complete the project. In various example embodiments, the determination module 220 is further configured to determine the plurality of items based on the feedback that describes the plurality of items being used together to complete the project. For instance, the determination module 220 may determine the plurality of items based on a positive review left by the previous user regarding the plurality of items. Moreover, the determination module 230 may not include items that did not receive a favorable review. In various example embodiments, the determination module 220 is further configured to identify a first group of items are used prior to a second group of items in completing the project. The first group of items and the second group of items may both be included in the plurality of items being used together to complete the project. For instance, completion of the project may occur in various phases or steps. The first group of items may be involved in completing a first step that is necessary before advancing to a further step. Moreover, the second group of items may not be necessarily involved in completing the first step. In various example embodiments, the determination module 220 is further configured to identify the plurality of items as being included in a wish list of items. The wish list of items may be selected by the previous device operated by the previous user. In various example embodiments, the determination module 220 is further configured to determine that each item among the plurality of items is compatible with one another. For instance, the items may be determined by the determination module 220 as capable of being physically coupled to one another. As another example, the items may be determined by the determination module 220 as a minimum set of items needed to complete the project.

In various example embodiments, the determination module 220 is further configured to determine the plurality of items based on a relationship model. The relationship model may depict relationships among a set of items. The relationships may include groupings of items by category, type, compatibility, or any suitable combination thereof. In various example embodiments, the relationship model is arranged as a hierarchy. In other words, the relationship model may be a representation of compatible items arranged hierarchically within the model. In another case, the relationship model may be a representation of items of the same category arranged hierarchically within the model. Each of the plurality of items may be represented within the hierarchy and identified by the determination module 220 from the hierarchy. Moreover, the arrangement of the items within the hierarchy of models may indicate a sequence in which to use the plurality of items. For instance, the hierarchy of the models may be arranged from top to bottom as a tree. The arranged items at the top (e.g., parent node) of the hierarchy may be indicated as being used sequentially prior to the items arranged below (e.g., child node).

In various example embodiments, the project may span across various seasons. For example, the project may involve construction of an outdoor deck which may take several months. As a result, there may be significant delay between uses of items within the determined plurality of items and the user may not purchase all of the plurality of items at once. In this event, the determination module 220 may be further configured to issue a signal to indicate to the user an item within the plurality of items that is ready to be used. The signals may be issued periodically, seasonally, and any suitable combination thereof. The signals issued by the determination module 220 may be used to remind the user that an item within the plurality of items is available to be purchased and used to complete the project. Moreover, the determination module 220 may detect that a first stage of the project has been completed prior to issuing the signals.

In various example embodiments, the determination module 220 may be further configured to detect reverse compatibility of an item among the plurality of items used to complete the project. In other words, the determination module 220 may identify that a previous version of an item among the plurality of items is also compatible with the other items among the plurality of items and may be used to complete the project. For example, an older version of a part may be determined to be compatible and capable of completing the project that involves constructing a model airplane. In various example embodiments, the determination module 220 may be further configured to identify the plurality of items used to complete the project as being purchased together or kept by a previous user after being purchased together by the previous user. In some instances, the determination module 220 may also consider other items related to the plurality of items used to complete the project. For instance, a previous user that purchased a first item used to complete the project may also have purchased a second item together with the first item. As a result, the first and second items may be related with one another, and may be considered to be compatible with one another and therefore included in the plurality of items used to complete the project.

In various example embodiments, the generation module 230 is configured to display a single page that includes the plurality of items that are used together to complete the project. In various example embodiments, the generation module 230 is further configured to generate a description of each item of the plurality of items in a portion of the single display page. The description may describe attributes of the item, price of the item, type of item, availability of the item, or any suitable combination thereof. In various example embodiments, the generation module 230 is further configured to generate links to item pages of each of the plurality of items that are used together to complete the project. The links may be displayed next to the description of each of the plurality of items. Moreover, each of the links may be operable to direct the user to an item page corresponding to an item among the plurality of items.

In various example embodiments, the presentation module 240 is configured to present the single display page that includes the plurality of items. The single display page may be presented by the presentation module 240 to the device operated by the user. In various example embodiments, the presentation module 240 is further configured to present the web page that includes the description of the project. The web page is presented by the presentation module 240 to the device operated by the user. Moreover, the web page may include the link that is operable to send the request that indicates the project from the device operated by the user. In various example embodiments, the presentation module 240 is further configured to present the first group of items prior to presenting the second group of items. As stated previously, the determination module 220 may identify the first group of items that are used prior to the second group of items. Moreover, the presentation module 240 may present the second group of items to the device operated by the user a predetermined period of time after presenting the first group of items.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

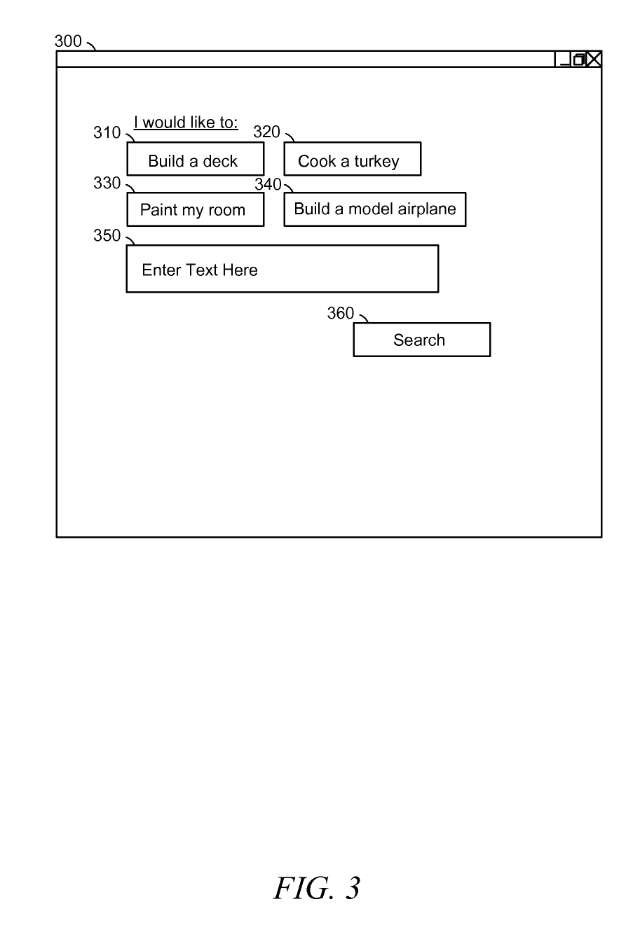

FIG. 3 is an example user interface 300 depicting a set of controls operable to provide search criteria, according to some example embodiments. The example user interface 300 may include a first button 310, a second button 320, a third button 330, a fourth button 340, an input field 350, and a search button 360. Operation of the first button 310 may be used to send a request that indicates building a deck as a project to be completed. Operation of the second button 320 may be used to send a request that indicates cooking a turkey as a project to be completed. Operation of the third button 330 may be used to send a request that indicates painting a room as a project to be completed. Operation of the fourth button 340 may be used to send a request that indicates building a model airplane as a project to be completed. An operation of any of the first, second, third, and fourth buttons may include clicking, selecting, tapping, performing a gesture, or any suitable combination thereof. The input field 350 may be used to receive search criteria such as a description of a project to be completed. Once the search criteria have been entered into the input field 350, operation of the search button 360 may be used to perform a search based on the search criteria.

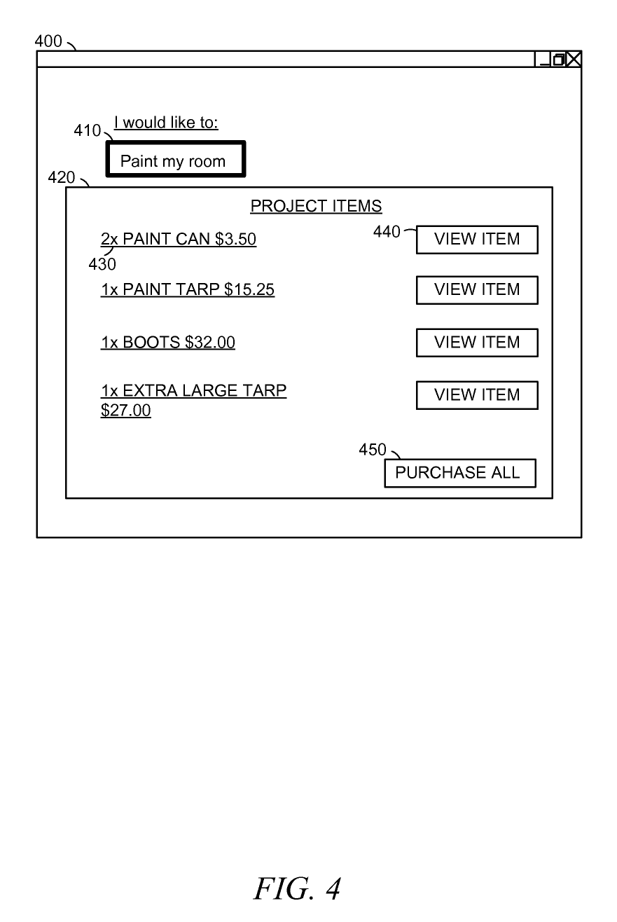

FIG. 4 is an example user interface 400 depicting a display page of a plurality of items, according to some example embodiments. The example user interface 400 may include a description of the project to be completed 410. Moreover, the example user interface 400 may include a plurality of items 430 displayed in a portion 420 of the example user interface 400. The plurality of items 430 may be determined by the determination module 220 as being items that are used together to complete the project. In various example embodiments, the example user interface 400 may include a link 440 that is operable to view an item page corresponding to the item 430. Clicking on the link 440 may redirect a user to the item page corresponding to the item 430. In various example embodiments, the example user interface 400 may also include a purchase all button 450 that enables the user to purchase the plurality of items 430 that are used together to complete the project.

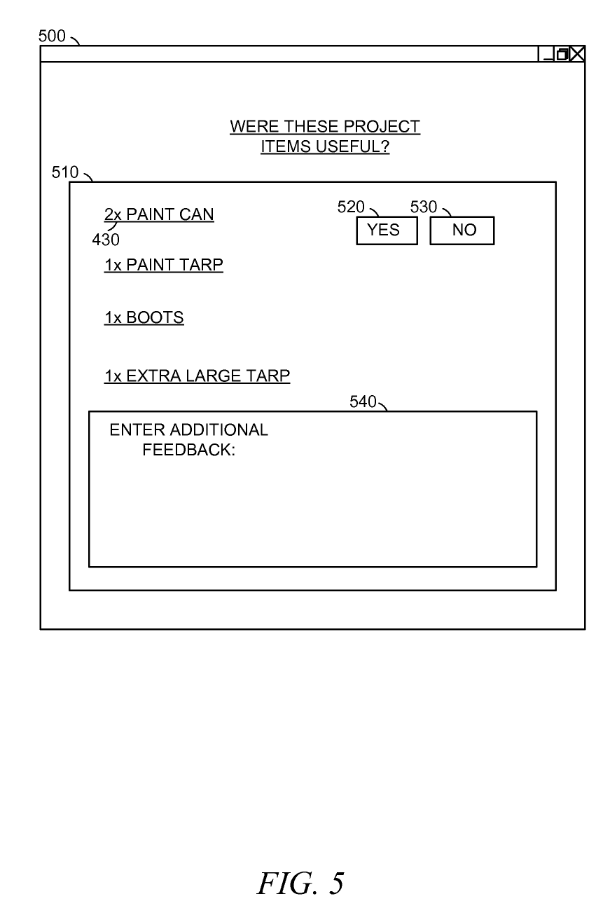

FIG. 5 is an example user interface 500 depicting a feedback page, according to some example embodiments. The example user interface 500 may display the plurality of items used to complete the project, including the item 430 as also depicted in FIG. 4. Moreover, the example user interface 500 may display a first button 520 and a second button 530 each operable to provide feedback with regards to the plurality of items (e.g., whether the plurality of items were helpful). Lastly, the example user interface 500 may include a text field 540 operable to receive additional feedback regarding the plurality of items used to complete the project. In various example embodiments, the reception module 220 may detect the feedback left by the user in the text field 540 regarding the plurality of items. Moreover, the determination module 220 may use the detected feedback in determining the plurality of items for a further user requesting a similar project to paint the room.

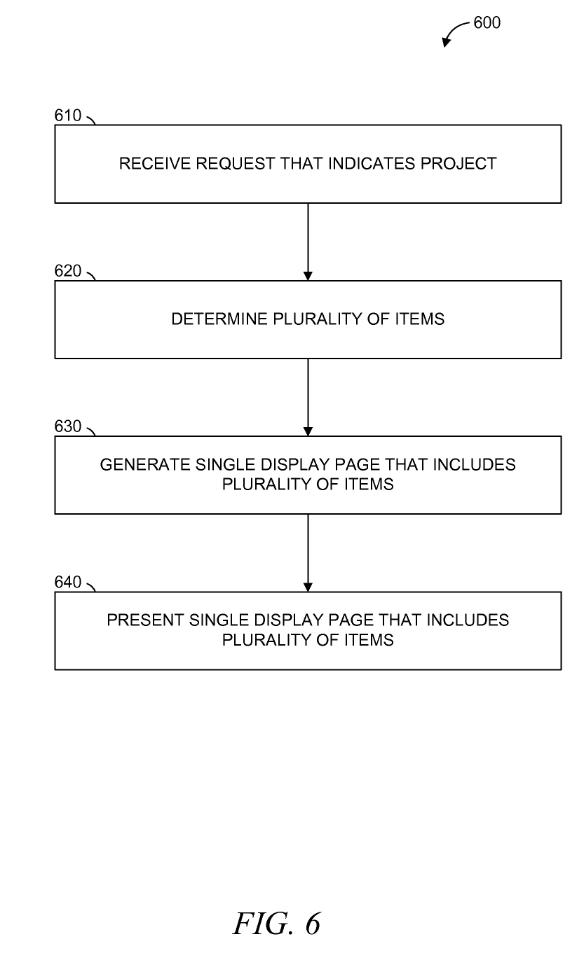

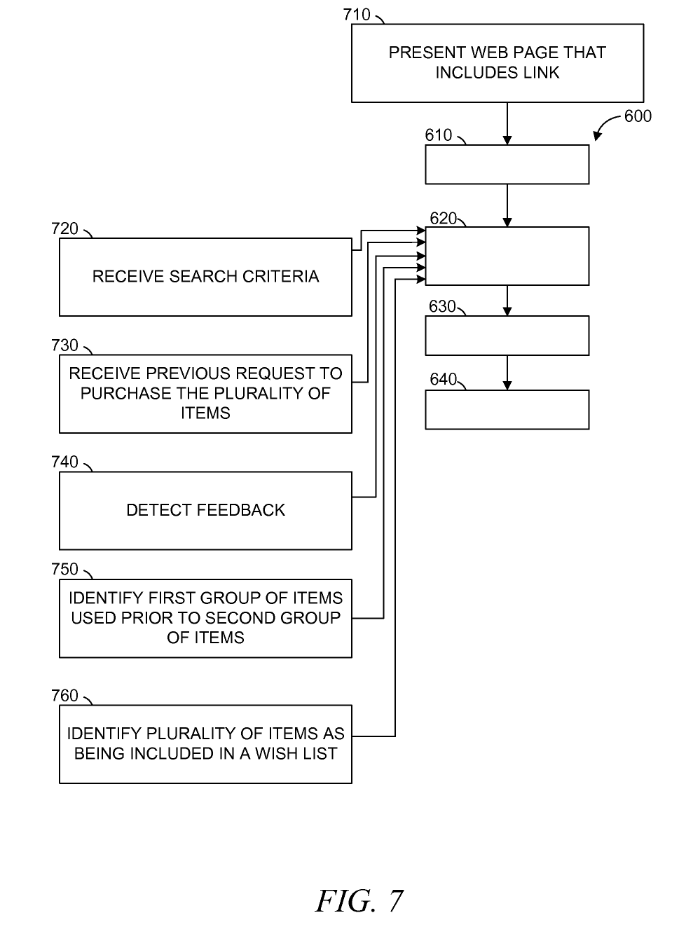

FIG. 6-7 are flowcharts illustrating operations of a method 600 of presenting a single display page that includes a plurality of items, according to some example embodiments. Operations in the method 600 may be performed by the project machine 110, using modules described above with respect to FIG. 2. As shown in FIG. 6, the method 600 includes operations 610, 620, 630, and 640. The method 600 may begin at operation 610 with the reception module 210 receiving the request that indicates a project to be completed, the request being received from a device operated by a user.

At operation 620, the determination module 220 determines a plurality of items that are used together to complete the project. In various example embodiments, each of the plurality of items is listed as being available for sale.

At operation 630, the generation module 230 generates a single display page that includes the plurality of items that are used together to complete the project.

At operation 640, the presentation module 240 presents the single display page that includes the plurality of items to the device operated by the user.

As shown in FIG. 7, the method 600 may include one or more of operations 710, 720, 730, 740, 750, and 760. At operation 710, the presentation module 240 presents a web page that includes a link operable to send the request that indicates the project. The link may include a description of the project to be completed. In various example embodiments, the reception module 210 receives the request from the device operated by the user in response to operation of the link.

At operation 720, the reception module 210 receives search criteria from the device operated by the user. In response, the determination module 220 determines the plurality of items based on the search criteria received at the reception module 210.

At operation 730, the reception module 210 receives a previous request to purchase the plurality of items that are used together to complete the project. The previous request may be received from a previous device operated by a previous user. In response, the determination module 220 determines the plurality of items based on the previous request to purchase the plurality of items.

At operation 740, the reception module 210 detects feedback that describes the plurality of items being used together to complete the project. The feedback may be received from a previous device operated by a previous user. In response, the determination module 220 determines the plurality of items based on the detected feedback.

At operation 750, the determination module 220 identifies a first group of items that are used prior to a second group of items. In response, the presentation module 240 presents the first group of items prior to presenting the second group of items.

At operation 760, the determination module 220 identifies the plurality of items as being included in a wish list of items selected by a previous device operated by a previous user.

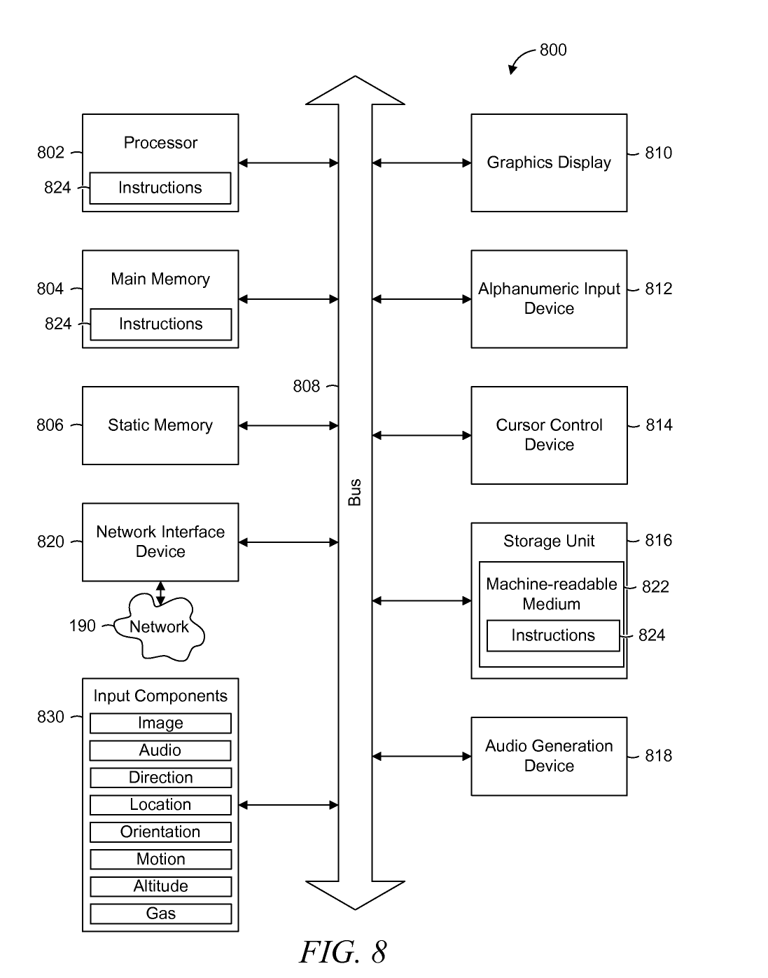

FIG. 8 is a block diagram illustrating components of a machine 800, according to some example embodiments, able to read instructions 824 from a machine-readable medium 822 (e.g., a machine-readable storage medium, a computer-readable storage medium, or any suitable combination thereof) and perform any one or more of the methodologies discussed herein, in whole or in part. Specifically, FIG. 8 shows the machine 800 in the example form of a computer system within which the instructions 824 (e.g., software, a program, an application, an applet, an app, or other executable code) for causing the machine 800 to perform any one or more of the methodologies discussed herein may be executed, in whole or in part. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include any collection of machines that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a graphics display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, an audio generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered machine-readable media (e.g., tangible and non-transitory machine-readable media). The instructions 824 may be transmitted or received over the network 190 via the network interface device 820. For example, the network interface device 820 may communicate the instructions 824 using any one or more transfer protocols (e.g., hypertext transfer protocol (HTTP)).

In some example embodiments, the machine 800 may be a portable computing device, such as a smart phone or tablet computer, and have one or more additional input components 830 (e.g., sensors or gauges). Examples of such input components 830 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving a request that indicates a project to be completed, the request being received from a device operated by a user;
determining a plurality of items that are used together to complete the project, the plurality of items each listed as being available for sale;
generating a single display page that includes the plurality of items that are used together to complete the project; and
presenting the single display page that includes the plurality of items to the device operated by the user.

2. The method of claim 1, wherein the receiving the request that indicates the project includes receiving a description of a product to be constructed.

3. The method of claim 1, further comprising:
presenting a web page that includes a link operable to send the request that indicates the project, the link including a description of the project to be completed, and wherein the request is received from the device operated by the user in response to operation of the link.

4. The method of claim 1, wherein the receiving the request that indicates the project includes receiving search criteria from the device operated by the user, and wherein the determining the plurality of items is based on the search criteria.

5. The method of claim 1, further comprising:
receiving a previous request to purchase the plurality of items that are used together to complete the project, the previous request received from a previous device operated by a previous user; and wherein the determining the plurality of items is based on the previous request to purchase the plurality of items that are used together to complete the project.

6. The method of claim 1, further comprising:
detecting feedback that describes the plurality of items being used together to complete the project, the feedback received from a previous device operated by a previous user, and wherein the determining the plurality of items that are used together to complete the project is based on the detected feedback.

7. The method of claim 1, wherein determining the plurality of items that are used together to complete the project includes identifying a first group of items that are used prior to a second group of items, and wherein presenting the plurality of items includes presenting the first group of items prior to presenting the second group of items.

8. The method of claim 1, wherein the generating the single display page includes generating a description of each of the plurality of items in a portion of the single display page.

9. The method of claim 1, wherein the generating the single display page includes generating links to item pages of each of the plurality of items that are used together to complete the project.

10. The method of claim 1, wherein the determining the plurality of items that are used together to complete the project includes identifying the plurality of items as being included in a wish list of items selected by a previous device operated by a previous user.

11. A system comprising:
a reception module configured to receive a request that indicates a project to be completed, the request being received from a device operated by a user;
a determination module configured to determine a plurality of items that are used together to complete the project, the plurality of items each listed as being available for sale;
a generation module configured to generate a single display page that includes the plurality of items that are used together to complete the project; and
a presentation module configured to present the single display page that includes the plurality of items to the device operated by the user.

12. The system of claim 11, wherein the reception module is further configured to receive a description of a product to be constructed.

13. The system of claim 11, wherein the presentation module is further configured to present a web page that includes a link operable to send the request that indicates the project, the link including a description of the project to be completed, and wherein the reception module is further configured to receive the request from the device operated by the user in response to operation of the link.

14. The system of claim 11, wherein the reception module is further configured to receive search criteria from the device operated by the user, and wherein the determination module is further configured to determine the plurality of items based on the search criteria.

15. The system of claim 11, wherein the reception module is further configured to receive a previous request to purchase the plurality of items that are used together to complete the project, the previous request received from a previous device operated by a previous user, and wherein the determination module is further configured to determine the plurality of items based on the previous request.

16. The system of claim 11, wherein the reception module is further configured to detect feedback that describes the plurality of items being used together to complete the project, the feedback received from a previous device operated by a previous user, and wherein the determination module is further configured to determine the plurality of items based on the feedback.

17. The system of claim 11, wherein the determination module is further configured to identify a first group of items that are used prior to a second group of items, and wherein the presentation module is further configured to present the first group of items prior to presenting the second group of items.

18. The system of claim 11, wherein the generation module is further configured to generate links to item pages of each of the plurality of items that are used together to complete the project.

19. The system of claim 11, wherein the determination module is further configured to identify the plurality of items as being included in a wish list of items selected by a previous device operated by a previous user.

20. A non-transitory machine-readable medium storing instructions that, when executed by one or more processors of a machine, cause the machine to perform operations comprising:
receiving a request that indicates a project to be completed, the request being received from a device operated by a user;
determining a plurality of items that are used together to complete the project, the plurality of items each listed as being available for sale;
generating a single display page that includes the plurality of items that are used together to complete the project; and
presenting the single display page that includes the plurality of items to the device operated by the user.
